(19) United States
(12) Patent Application Publication
(10) Pub. No.: US 2026/0041032 A1
(43) Pub. Date: Feb. 12, 2026

(54) ADAPTIVE CRUISE CONTROL SYSTEM AND METHOD FOR A WORK VEHICLE

(71) Applicant: Deere & Company, Moline, IL (US)

(72) Inventors: Mahesh Somarowthu, Pune (IN); Noel W. Anderson, Fargo, ND (US); Ravi Kiran Madu, Pune (IN)

(21) Appl. No.: 18/796,406

(22) Filed: Aug. 7, 2024

(51) Int. Cl. A01D 34/00; A01D 34/74

(52) U.S. Cl. CPC A01D 34/008; A01D 34/74

(57) ABSTRACT

Adaptive cruise control is provided for a work vehicle, for example a work vehicle lacking global navigation satellite system or equivalent positioning components. Work vehicle operating values corresponding to at least an orientation and an advance speed of the work vehicle are monitored, along with a steering angle. At least while a cruise control operating mode is enabled, and further wherein the sensed steering angle corresponds to forward advance by the work vehicle, an advance speed for the work vehicle is commanded to a first speed setting. Upon determining that the sensed steering angle exceeds a specified sensitivity value, the advance speed for the work vehicle is commanded to a second speed setting, wherein at least a maximum value for the second speed setting is automatically determined based on at least the one or more work vehicle operating values corresponding to the orientation of the work vehicle.

### FIELD OF THE DISCLOSURE

The present disclosure relates generally to work vehicles, such as for example compact work vehicles including grass mowing machines, snow removers, or the like, and more particularly to adaptive cruise control systems and methods with respect to work vehicles.

### BACKGROUND

Work vehicles as discussed herein may generally but without limitation comprise compact tractors, such as riding or automated grass mowing machines for use with respect to lawns or golf courses, snow removing equipment, or the like. It may be understood that a work vehicle as disclosed herein may include integrated equipment for the mowing of grass or removal of snow, among other potential applications within the scope of the present disclosure, or that the work vehicle may comprise a tractor or equivalent vehicle having an attachment configured to perform grass mowing or snow removal features, among others, while the tractor traverses a corresponding work area.

The speed of compact tractors can conventionally be controlled either manually or automatically. Vehicle speed, when manually controlled, is adjusted through the use of an accelerator that is adjusted by a foot pedal or hand device. One type of automatic speed control is also known as “cruise control”.

For such work vehicles, cruise control is typically enabled to hold the vehicle speed to a desired setpoint. When a turn is required, either the advance speed or the steering angle of the vehicle is preferably optimum. In this scenario the operator typically overrides the auto mode (i.e., cruise control) with manual operation, which provides the opportunity to control (and typically reduce) the turn speed. It may be appreciated that maintaining a slow speed is much needed in such contexts, as otherwise a rollover of the vehicle may result, among other undesired effects. Several factors to be noted in selecting and maintaining a consistent ground speed over the work area (e.g., lawn, golf course) may include operator skill, turf damage which may result from irregular operating speeds, the desire to avoid rollovers, and operator fatigue that may result from continuous monitoring and adjustments among other things. In addition, at higher ground speeds the turning radius of the work vehicle becomes larger, and if the advance speed is not reduced as it approaches the end of a row or other areas requiring tight curvature segments, the work vehicle may tend to override the path segment or crosswise skid at times.

Some solutions for controlling work vehicle operations rely on position sensing, for example using global navigation satellite system (GNSS) devices to control vehicle direction. However, such devices are typically unavailable on work vehicles such as compact lawn tractors, wherein extended cruise control features are also conventionally unavailable for such work vehicles during turns.

### BRIEF SUMMARY OF THE DISCLOSURE

The current disclosure provides an enhancement to conventional systems, at least in part by adding extended cruise mode during turns for work vehicles lacking a GNSS receiver or equivalent location sensing equipment, and accordingly enabling a more robust control of ground speed during ground working operations.

Control systems associated with the work vehicles, having integrated therein or otherwise associated with various machine-mounted sensors and software algorithms, may monitor or otherwise determine inputs corresponding to one or more control variables, examples of which may include (without limitation): a steering angle (e.g., based on stick position); ground speed; vehicle pitch or roll; percentage wheel slip; engine load; and the like. In some embodiments, the tilt of the work vehicle may be measured, such as with a tilt sensor. If the tilt exceeds a threshold value, the speed of the work vehicle may be reduced.

In an embodiment, a computer-implemented method is disclosed herein for providing adaptive cruise control for a work vehicle lacking global navigation satellite system or equivalent positioning components. Work vehicle operating values corresponding to at least an orientation and an advance speed of the work vehicle are monitored, along with a steering angle. At least while a cruise control operating mode is enabled, and further wherein the sensed steering angle corresponds to forward advance by the work vehicle, an advance speed for the work vehicle is commanded to a first speed setting. Upon determining that the sensed steering angle exceeds a specified sensitivity value, the advance speed for the work vehicle is commanded to a second speed setting, wherein at least a maximum value for the second speed setting is automatically determined based on at least the one or more work vehicle operating values corresponding to the orientation of the work vehicle.

In one optional and exemplary aspect according to the above-referenced embodiment, at least initial values for the first speed setting, the second speed setting, and the sensitivity value may be specified by user input received via a user interface.

In another optional and exemplary aspect according to the above-referenced embodiment, the method may further comprise validating or automatically adjusting the initial values for the first speed setting, the second speed setting, and the sensitivity value according to a specified type of work vehicle operation.

In another optional and exemplary aspect according to the above-referenced embodiment, wherein a maximum value for the first speed setting may be automatically determined based on at least the one or more work vehicle operating values corresponding to the orientation of the work vehicle.

In another optional and exemplary aspect according to the above-referenced embodiment, the work vehicle may comprise a cutting deck having a cut height, wherein the cut height may be automatically adjusted from a first height setting to a second height setting upon determining that the sensed steering angle exceeds the specified sensitivity value.

In another optional and exemplary aspect according to the above-referenced embodiment, a maximum value for the second height setting may be automatically determined based on at least the one or more work vehicle operating values corresponding to the orientation of the work vehicle.

In another optional and exemplary aspect according to the above-referenced embodiment, a value may be calculated corresponding to traction of the work vehicle with respect to a ground surface being traversed, wherein the maximum value for the second speed setting may then be automatically determined further based on the value corresponding to traction of the work vehicle.

In another optional and exemplary aspect according to the above-referenced embodiment, a maximum value for the first speed setting may be automatically determined based on at least the value corresponding to traction of the work vehicle.

In another optional and exemplary aspect according to the above-referenced embodiment, the method may comprise receiving and storing historical input data sets comprising the one or more work vehicle operating values corresponding to at least the orientation and the advance speed of the work vehicle, and the sensed steering angle. A model may be trained by correlating the input data sets to observed outcomes relating to operator safety and/or traction of the work vehicle with respect to a ground surface being traversed. Values for the first speed setting, the second speed setting, and the sensitivity value for a current work vehicle operation may accordingly be specified automatically by reference to the trained model.

The model may be trained remotely from the work vehicle, for example at a server network or other computing system having one or more processors, wherein the trained model may be transmitted to the work vehicle for usage during subsequent operations.

In another optional and exemplary aspect according to the above-referenced embodiment, the received and stored input data sets may further relate to a respective type of work vehicle operation, and the at least initial values for the first speed setting, the second speed setting, and the sensitivity value may accordingly be specified automatically by reference to the developed model and a current type of work vehicle operation.

In another embodiment as disclosed herein, a work vehicle may comprise a plurality of ground engaging units configured to be driven according to a commanded advance speed, a work implement movable to define a height relative to a ground surface, one or more sensors configured to generate output signals corresponding to at least a steering angle, an orientation, and an advance speed of the work vehicle, and a controller. The controller may be configured, at least while a cruise control operating mode is enabled, to direct the performance of steps in a method according to the above-referenced embodiment and optionally any one or more of the associated aspects thereof.

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

FIG. 1 is a perspective view of an exemplary embodiment of a work vehicle according to the present disclosure.

FIG. 2 is a block diagram representing an exemplary embodiment of a vehicle control system for a work vehicle of the present disclosure.

FIG. 3 is a flowchart representing an exemplary embodiment of a method according to the present disclosure.

FIG. 4 is a graphical diagram representing an exemplary embodiment of a user interface according to the present disclosure.

### DETAILED DESCRIPTION

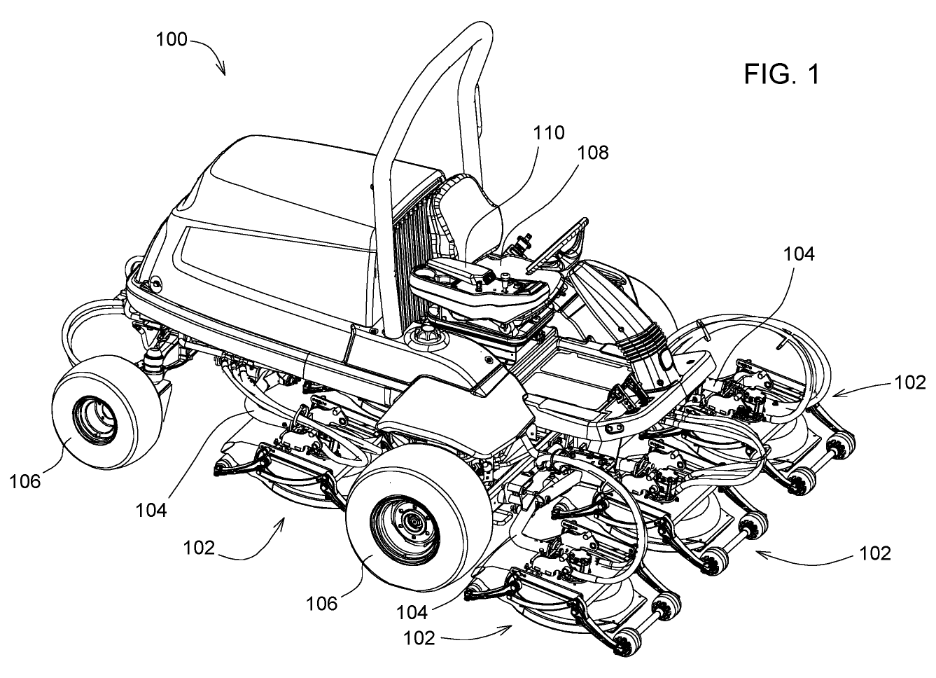

Referring now to the drawings and particularly to FIG. 1, a representative work vehicle is generally designated by the number 100 and may be briefly described herein. In an embodiment as shown, the work vehicle 100 may be a riding or automated grass mowing machine having a work implement 102, which in the context of a grass mowing machine takes the form of multiple cutting decks 102, as will accordingly be referenced herein as an example of the work implement without limiting the scope of the present disclosure otherwise. The multiple cutting decks 102 may in various embodiments be provided in one or more rows from front to rear, as in the illustrated example.

The work vehicle 100 in an embodiment may be powered by internal combustion engine, and may have a hydrostatic traction drive circuit, and/or hydraulic mow circuit, and a hydraulic lift and lower circuit for the cutting decks 102. Each cutting deck 102 may be pivotably supported at the end of a lift arm 104 which the operator may actuate with one or more hydraulic cylinders or electric lift mechanisms to raise or lower the cutting decks 102 between mowing positions and transport positions.

The work vehicle 100 may further be provided with a steering mechanism for at least commanding or controlling a steering angle of ground engaging units 106, such as for example multiple wheels 106, which are further driven to arrive at a controlled ground speed/ advance speed.

As used herein, directions with regard to work vehicle 100 may be referred to from the perspective of an operator seated thereon; the left of work vehicle 100 is to the left of such an operator, the right of work vehicle is to the right of such an operator, the front or fore of work vehicle is the direction such an operator faces, the rear or aft of work vehicle is behind such an operator, the top of work vehicle is above such an operator, and the bottom of work vehicle below such an operator.

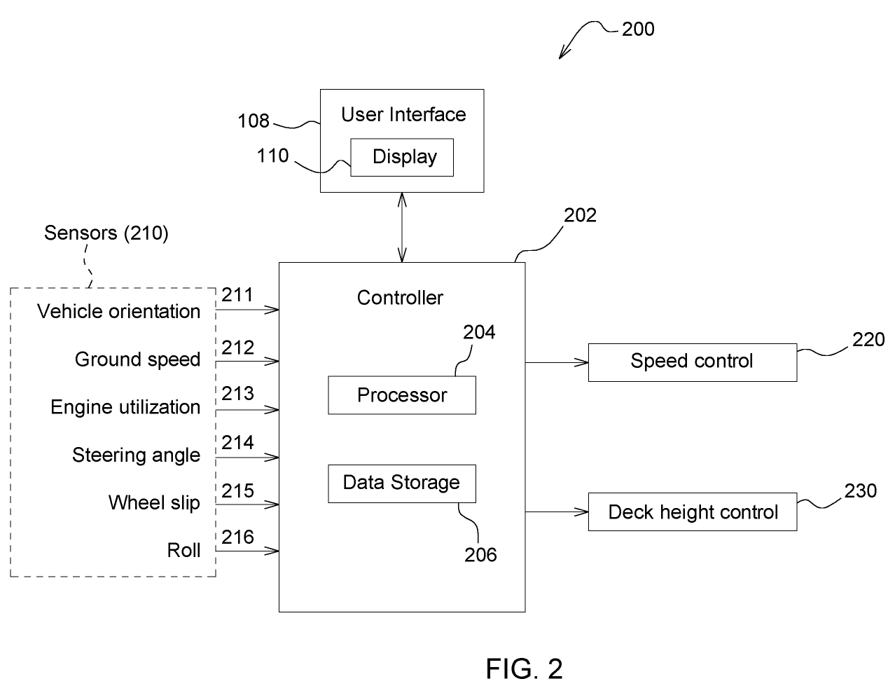

A user interface 108 (further represented in FIG. 2) may be located proximate to the operator seat for use by an operator of the work vehicle 100. The user interface 108 may include or otherwise be functionally linked to one or more corresponding user interface tools for input and/or output with respect to a controller 202 as further described below. Such user interface tools may for example include a plurality of user selectable touch buttons (e.g., soft buttons), to select from a plurality of commands or menus, each of which may be selectable through a touch screen having a display unit 110. Touch buttons respond to touch and do not include a mechanical component requiring a force sufficient to engage mechanical features. The touch screen may be a graphical user interface configured to display icons as well as content of work vehicle applications. The display unit 110 may be configured to display in the touch screen still images, moving images, and video content through one or more different types of displays. The display unit 110 may include, but is not limited, to cathode ray tube (CRT) displays, light-emitting diode (LED) displays, and liquid crystal displays (LCD).

Another form of user interface (not shown) may take the form of a display unit that is generated on a mobile (i.e., carried by the operator) or remote (i.e., not onboard) computing device, which may display outputs such as status indications and/or otherwise enable user interaction such as the providing of inputs to the system. In the context of a remote user interface, data transmission between for example the vehicle control system 200 and the user interface may take the form of a wireless communications system and associated components as are conventionally known in the art.

The work vehicle 100 may further include operator-accessible interface tools such as an accelerator pedal or hand lever which enables the operator to adjust the speed of the vehicle. Other exemplary tools accessible from the operator seat may include a steering wheel, a plurality of operator selectable touch buttons configured to enable the operator to control the operation and function of the work vehicle 100, and any accessories or implements being driven by the work vehicle, including for example a height of the cutting decks 102.

As schematically illustrated in FIG. 2, an embodiment of a control system 200 for a work vehicle 100 as disclosed herein includes a controller 202. The controller 202 may be part of an overall work vehicle control unit, or it may be a separate control module corresponding to speed control 220 and/or deck height control 230 functions as further described herein. The controller 202 may include the user interface 108 and optionally be mounted proximate to the operator seat at a control panel.

The controller 202 is configured to receive input signals from one or more sensors 210 or equivalent input data sources. The one or more sensors 210 may generally be configured to generate signals representative of work vehicle conditions or operations, optionally including but not limited to vehicle orientation 211, ground speed 212, engine utilization 213, steering angle 214, wheel slip 215, roll 216, and the like.

Some sensors 210 may generate output signals which directly represent the work vehicle condition or operation. For example, vehicle advance speed, vehicle orientation, angular velocity, and/or the like may be directly sensed using appropriate sensors in various embodiments. Vehicle advance speed may for example be sensed directly using a speedometer or the equivalent, or alternatively may be detected by sensing a commanded vehicle advance speed, such as via input signals from pedal sensors which may include PWM voltages indicating desired ground speed based on pedal position at a known and/or fixed engine speed.

Other examples of sensors or equivalent data sources may provide outputs from which relevant work vehicle conditions or operations may be derived, calculated, or otherwise determined. Steering angle may for example correspond to a sensed position of a joystick associated with the operator area of the work vehicle.

In a particular exemplary embodiment, vehicle orientation 211 may be detected using vehicle kinematics sensors such as for example inertial measurement units (IMUs). IMUs may include a number of sensors including, but not limited to, accelerometers, which measure (among other things) velocity and acceleration, gyroscopes, which measure (among other things) angular velocity and angular acceleration, and magnetometers, which measure (among other things) strength and direction of a magnetic field. Generally, an accelerometer provides measurements, with respect to (among other things) force due to a change in speed, while a gyroscope provides measurements, with respect to (among other things) rigid body motion. The magnetometer provides measurements of the strength and the direction of the magnetic field, with respect to (among other things) known internal constants, or with respect to a known, accurately measured magnetic field. The magnetometer provides measurements of a magnetic field to yield information on positional, or angular, orientation of the IMU; similarly to that of the magnetometer, the gyroscope yields information on a positional, or angular, orientation of the IMU. Accordingly, the magnetometer may be used in lieu of the gyroscope, or in combination with the gyroscope, and complementary to the accelerometer, in order to produce local information and coordinates on the position, motion, and orientation of the IMU.

The controller 202 of the work vehicle 100 may be configured to produce outputs, as further described below, to a user interface 108 associated with a display unit 110 for display to the human operator. The controller 202 may be configured to receive inputs from the user interface 108, such as user input provided via the user interface 108. Not specifically represented in FIG. 2, the controller 202 of the work vehicle 100 may in some embodiments further receive inputs from and generate outputs to remote devices associated with a user via a respective user interface, for example a display unit with touchscreen interface. Data transmission between for example the vehicle control system and a remote user interface may take the form of a wireless communications system and associated components as are conventionally known in the art.

In an embodiment, a remote server (not shown) such as in the form of a cloud server environment may include one or more processors functionally linked with the control system 200. In certain embodiments, a mobile or remote user interface, and/or the vehicle control system, may be further coordinated or otherwise interact with the remote server or other computing device for the performance of certain operations in a system as disclosed herein. In one embodiment for example, model development may be performed in a cloud server environment based on inputs received from a work vehicle, wherein validated models are downloaded to the work vehicle for use by the controller in a given operation or otherwise in certain embodiments accessible by the controller from the server during operation.

The controller 202 may be configured to generate control signals for controlling the operation of respective actuators, or signals for indirect control via intermediate control units, associated with a work vehicle speed control unit 220 and/or a cutting deck height control unit 230. The controller 202 may for example be electrically coupled to respective components of these and/or other systems by a wiring harness such that messages, commands, and electrical power may be transmitted between the controller 202 and the remainder of the work vehicle 100.

For example, where the work vehicle 100 may be propelled by an electric drive or electric motor, the propulsion control signal may control or modulate electrical energy, electrical current, electrical voltage provided to an electric drive or motor. The control signals generally vary with time as necessary to track the path plan. The lines that interconnect the components of the system may comprise logical communication paths, physical communication paths, or both. Logical communication paths may comprise communications or links between software modules, instructions, or data, whereas physical communication paths may comprise transmission lines, data buses, or communication channels, to name non-limiting examples.

In an embodiment, a cutting deck height control unit 230 may include one or more actuators commanded to positions based on respective cut height settings with respect to the ground surface being traversed, and in some cases further including sensors to detect an actual cut height for comparison against specified/ commanded cut heights to determine any error in the same, wherein automatic leveling of cutting decks may optionally be performed.

It may be understood that the controller described herein may be a single controller having all of the described functionality, or it may include multiple controllers wherein the described functionality is distributed among the multiple controllers.

Various operations, steps or algorithms as described in connection with the controller 202 can be embodied directly in hardware, in a computer program product such as a software module executed by a processor 204, or in a combination of the two. The computer program product can reside in RAM memory, flash memory, ROM memory, EPROM memory, EEPROM memory, registers, hard disk, a removable disk, or any other form of computer-readable medium or equivalent data storage 206 as known in the art. An exemplary computer-readable medium can be coupled to the processor such that the processor can read information from, and write information to, the memory/ storage medium. In the alternative, the medium can be integral to the processor. The processor and the medium can reside in an application specific integrated circuit (ASIC). The ASIC can reside in a user terminal. In the alternative, the processor and the medium can reside as discrete components in a user terminal.

The term “processor” 204 as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, e.g., a combination of a DSP and a microprocessor, a plurality of microprocessors, one or more microprocessors in conjunction with a DSP core, or any other such configuration.

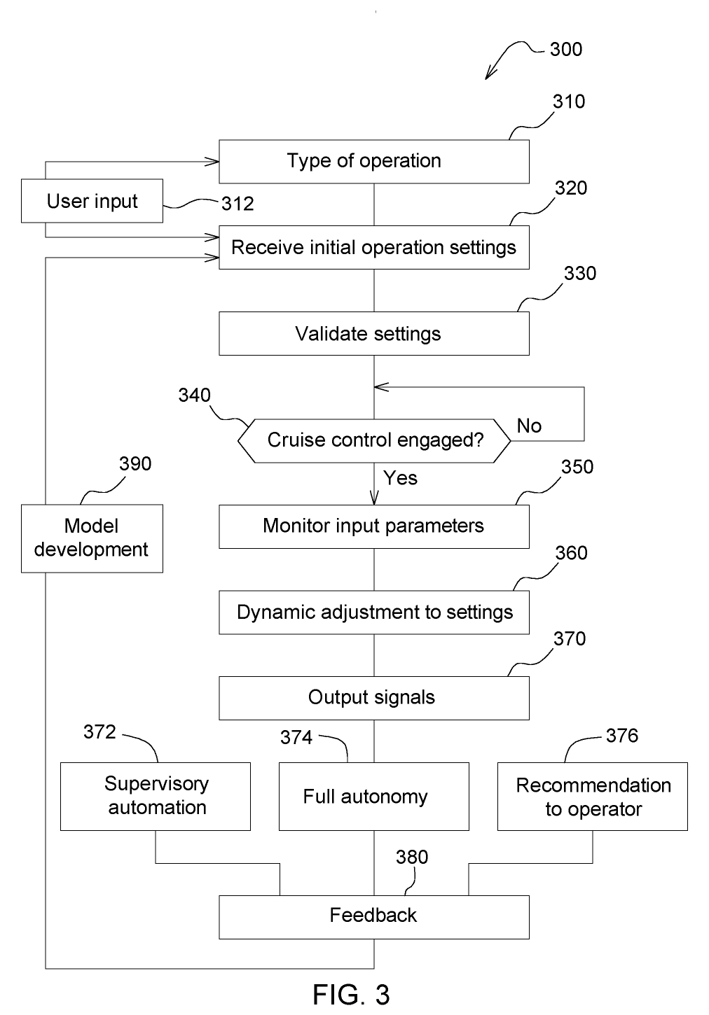

Referring next to FIG. 3, the depicted flowchart represents an exemplary embodiment of a method 300 for operating a work vehicle 100, and more particularly an adaptive and extended cruise control mode thereof. While the illustrated embodiment may include a specific arrangement of steps, inputs, outputs, and the like, it may be understood that certain steps may be combined, performed in a different order, or even omitted altogether in other embodiments within the scope of the present disclosure, unless otherwise specifically noted herein.

The method 300 may generally relate to extended cruise control features as provided for and implemented with respect to a current operation of a work vehicle 100, but it may be understood that various steps of the current operation overlap with steps associated with a corresponding model development process 390, as for example inputs provided in steps 310 and 320, as well as user input 312 and/or feedback in step 380, may be provided for iterative development and potential improvement of the models, prior to or otherwise while in the context of the current operation.

Step 310 as depicted relates to determining a type of operation for the work vehicle in question.

In an embodiment, at one level the type of operation may correspond to a configuration of the work vehicle and the type of task to be performed. The type of operation may for example be specified via user input (in step 312 as depicted), for example by manual selection from among various options associated with a user interface. The type of operation in an embodiment may alternatively be specified based on a detected configuration of the work vehicle, for example attachments thereto, wherein a grass cutting operation may be distinguishable from a snow removal operation. In an embodiment, the method may include provisionally determining a type of operation for the work vehicle upon startup and prompting the operator to confirm or otherwise modify the determined type of operation via the user interface.

In an embodiment, alternatively or in addition to the above-referenced example, the type of operation may correspond to different job execution plans, work areas (e.g., landscapes), operator-specific requirements, and the like. For example, one job execution plan with respect to a grass cutting operation may require different speeds than another job execution plan, based on a size of the work area, the risks of damage to be done to the work area or the work vehicle in view of work area characteristics, characteristics of one or more peripheral/ boundary regions of the work area which may be traversed but require specific operation settings, etc.

Step 320 as depicted in FIG. 3 relates to the reception, collection, or otherwise obtaining of inputs relating to initial operation settings for the work vehicle, such as for example steady state (i.e., straight path) advance speeds during a cruise control mode of operation, sensitivity settings for detecting or otherwise recognizing turn motions, respective maximum speed settings for steady state conditions and turn conditions, deck height settings, and the like.

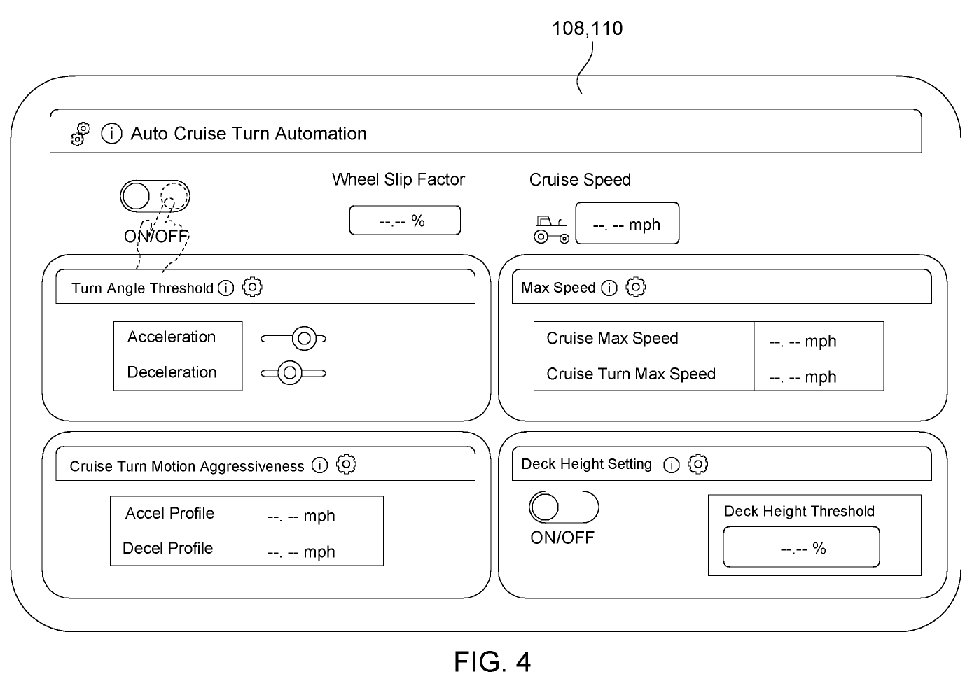

Some or all of the initial operation settings may for example be specified via user input (in step 312 as depicted), for example by manual selection from among various options associated with a user interface, one exemplary embodiment of which is depicted in FIG. 4. Some or all of the initial operation settings may for example initially or otherwise selectively be specified by reference to one or more models iteratively developed for this purpose. In one example, and as further described below with respect to step 390, such models may be developed for correlating input data sets for some or all of the operation settings to desired or unfavorable outcomes associated with the type of operation, such as for example rollovers of the work vehicle, involuntary movement of the work vehicle from a desired trajectory or path, damage to the ground surface, user input relating to discomfort, and the like.

In an embodiment, initial operation settings may be automatically provided, based on retrieval from one or more models or simply based on the type of operation, most recent operation, or the like, but further manually adjustable based on the preferences of the current operator or other authorized user. The manual adjustments to settings may be made prior to the operation, or in some embodiments during operation as well based for example on manual observation of conditions, outcomes, or otherwise general considerations of safety and/or comfort.

These initial operation settings may preferably be validated in step 330 as depicted, either for example to automatically validate settings provided via user input, or to enable user input or prompt user input validating settings that have been automatically provided.

In the context of a current work vehicle operation, and upon obtaining the respective inputs in steps 310 and 320, the illustrative method 300 may include a step 340 of determining whether a cruise control mode has been enabled. For example, the system may enable user selection from between multiple operating modes, at least one of which includes cruise control. In various embodiments, cruise control options may include a supervisory automation option (illustrated with respect to step 372), a fully autonomous cruise control option wherein cruise control features are automatically enabled and implemented (illustrated with respect to step 374), a cruise control option in which cruise control features are automatically determined but merely recommended and which must be manually implemented (illustrated with respect to step 376), a cruise control option in which cruise control features must be manually enabled but then may be automatically implemented, etc.

In various embodiments, whereas for example braking and acceleration functions may be performed automatically during an enabled cruise control feature, such functions may be manually overridden by the operator via braking and/or acceleration inputs from appropriate user interface tools (e.g., foot pedal, joystick). In an embodiment, a manual override of the braking and acceleration functions may only temporarily remove the automatic implementation of the braking and acceleration functions, which otherwise resume when the operator is no longer manually engaging the appropriate user interface tools.

Step 350 as depicted relates to the reception, collection, calculation, or otherwise obtaining of inputs for parameters relating to machine operating values, such as for example vehicle orientation 211, ground speed 212, engine utilization/ load 213, steering angle 214, wheel slip 215, roll 216, and the like as previously noted by reference to FIG. 2. The inputs may be understood as representing actual and substantially real-time machine operating values, wherein “substantially real-time” may typically indicate the values are as close to real-time as possible while accounting for some inherent delays in sensing, converting, transmitting, or otherwise indicating to the respective values to the controller during the work vehicle operation.

Some or all of the obtained inputs corresponding to actual and real-time machine operating values may be compared to corresponding initial operation settings to determine the need for responsive action such as for example control signals or other forms of intervention. Specifically, various embodiments of a method 300 as disclosed herein determine a steering angle (or turning angle) of the work vehicle, and directly control at least an advance speed of the work vehicle based on at least a turn state derived from the steering angle. In other words, if the work vehicle is deemed to be traveling in a steady state (e.g., straight path) trajectory, a first cruise speed setting may be applied, whereas upon determining that the work vehicle is turning a second cruise speed setting may be applied. The second cruise speed setting may be a predetermined value, or may relate to a maximum speed value for turns.

In an embodiment, a speed value or maximum speed value may be determined based on a sensed degree of the turn, as opposed to values which are applied for any detected turns greater than a threshold sensitivity relative to the baseline straight-path steering angle. For example, a sharp turn corresponding to the end of a row and turning around of the work vehicle may be treated differently than a short and transient turn relating, e.g., to navigation about an object within an otherwise continuing path, with respect to the desired changes to cruise speed settings.

Step 360 as depicted relates to an embodiment of the method 300 wherein one or more initial operation settings may be dynamically adjusted during operation, based for example on observed conditions. In one example as noted above, a pitch or roll or gyroscope sensor may be implemented to monitor vehicle orientation and/or angular velocity, wherein ground speed control settings may be selectively overwritten during turns if vehicle orientation is determined to be out of a specified range of operation for the turn. A specified range of vehicle orientation may be predetermined for all turns, or may be dependent on other factors such as for example the work area configuration and/or conditions, a work vehicle engine load, advance speed, and the like.

One of skill in the art may further appreciate that traction, for example as represented in the form of wheel slip, is important in the field of vehicle dynamics, for example as enabling an understanding of the relationship between the deformation of the work vehicle tires and the respective longitudinal forces (i.e., the forces responsible for forward acceleration and braking) acting there upon. In various embodiments as disclosed herein, the controller 202 and corresponding control algorithms may overwrite ground speed control settings during turns if the vehicle orientation is out of a specified range of operation for the turn as based further in part on a calculated or otherwise determined wheel slip, such as a percentage wheel slip. Wheel slip may for example be indicative of ground surface conditions wherein sufficiently excessive speeds on turns could produce undesirable damage to the turf, wherein such ground surface conditions may in some cases be transient or otherwise not identifiable from an initial or preliminary job execution plan alone.

It may be understood that an amount of wheel slip may be acceptable in some work area conditions, such as for example associated with a snow removal application, and for some operating states such as for example straight path operations, whereas an equivalent calculated wheel slip may be unfavorable in other contexts such as in a grass cutting operation on a golf course and require an adjustment in advance speed to avoid damaging the turf.

In various embodiments, vehicle operation settings may be validated or otherwise adjusted to account for predicted outcomes if speed is reduced by an expected amount going into a turn. For example, if the work vehicle is traveling at a relatively high speed which would be substantially reduced into a tight curvature, further in view of a sensed lack of traction, a required amount of time to effectively reduce the speed by the specified amount, or other conditions that could result in turf damage with such a sudden change in speed, the vehicle operation settings may be proactively adjusted to accommodate such conditions by for example reducing a maximum steady state speed.

Step 370 as depicted relates dynamic control of one or more work vehicle operations, for example via control signals provided from the controller 202 to one or more actuators via speed control unit 220, deck height control unit 230, or the like. The dynamic control may be utilized to control the one or more work vehicle operations, or for example to merely display recommendations associated therewith to the operator, in view of the specified cruise control mode.

While the cruise control option remains enabled (i.e., “yes” in response to the query in step 340), the method 300 may continue to perform iterations of steps 340 to 370, as may for example further include dynamic reconsideration and adjustment to work vehicle operation settings based on further inputs as they are received. Alternatively, when the cruise control option becomes disabled (i.e., “no” in response to the query in step 340), the method 300 may simply loop back to step 340 and wait until such time as a cruise control option becomes enabled again. In various embodiments, the cruise control features may be automatically disabled based on certain conditions, such as for example determining that the cruise control options have become impractical, result in unacceptable vehicle behavior, or the like.

Step 380 as depicted relates to the providing of feedback based on the monitored input parameters and values thereof, further in view of any generated output signals, as part of the model development stage 390 of method 300 for correlation of the input data sets with observed outcomes (favorable or otherwise). Observed outcomes may for example include tilt, slippage, or other loss of traction while remaining upright, involuntary changes in trajectory corresponding to wheel slip, identifications of ground surface damage, identifications of operator satisfaction, discomfort, and the like. Exemplary such observed outcomes may for example be provided manually (for example, via input from the user interface) and/or applied automatically in some embodiments using inputs corresponding or otherwise relevant to the type of outcome, such as for example using calculated wheel slip, load pressure sensors, etc.

In some embodiments, the model development stage 390 of method 300 may include validation and storage of the models, having been sufficiently developed over time using “test” input data sets and corresponding observed outcomes, for example including feedback 380 from a “current” data set, such that they may be retrieved and utilized during subsequent operations for prediction based on subsequent operations and corresponding data sets.

In some embodiments, the models may include neural network-based models having variable governing parameters which are optimized during training to better simulate (or approximate in a particular simulation) observed real-life results corresponding to an input data set. Such parameters may initially be set (e.g., user-specified) before training. Tuning of the hyperparameters, or in other words optimizing the values therefor, follows during training to obtain a set of values for the parameters corresponding to an accurate input-output mapping of the neural network for the training data set. In various embodiments, tuning of parameters may be performed automatically during or between training iterations, manually based on user selection via a user interface, or combinations thereof. In some embodiments the parameters are not initially user-specified but instead predetermined formulaically or otherwise according to a “best guess” distribution of possible simulation parameters, and in some embodiments may initially be unknown and merely derived during training. The parameters may for example determine aspects of the neural network structure and/or training parameters, such as the number of hidden neuron layers, number and/or definition of training steps, learning rates, batch size, and the like.

Thus it is seen that an apparatus and/or methods according to the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims. Each disclosed feature or embodiment may be combined with any of the other disclosed features or embodiments, unless otherwise specifically stated.

What is claimed is:

1. A computer-implemented method of adaptive cruise control for a work vehicle, the method comprising:
monitoring one or more work vehicle operating values corresponding to at least an orientation and an advance speed of the work vehicle;
while a cruise control operating mode is enabled, further wherein a sensed steering angle corresponds to forward advance by the work vehicle, commanding an advance speed for the work vehicle to a first speed setting; and
upon determining that the sensed steering angle exceeds a specified sensitivity value, commanding the advance speed for the work vehicle to a second speed setting,
wherein at least a maximum value for the second speed setting is automatically determined based on at least the one or more work vehicle operating values corresponding to the orientation of the work vehicle.

2. The method of claim 1, wherein at least initial values for the first speed setting, the second speed setting, and the sensitivity value are specified by user input received via a user interface.

3. The method of claim 2, further comprising validating or automatically adjusting the initial values for the first speed setting, the second speed setting, and the sensitivity value according to a specified type of work vehicle operation.

4. The method of claim 1, wherein a maximum value for the first speed setting is automatically determined based on at least the one or more work vehicle operating values corresponding to the orientation of the work vehicle.

5. The method of claim 1, wherein the work vehicle comprises a cutting deck having a cut height, and wherein the cut height is automatically adjusted from a first height setting to a second height setting upon determining that the sensed steering angle exceeds the specified sensitivity value.

6. The method of claim 5, wherein a maximum value for the second height setting is automatically determined based on at least the one or more work vehicle operating values corresponding to the orientation of the work vehicle.

7. The method of claim 1, comprising calculating a value corresponding to traction of the work vehicle with respect to a ground surface being traversed, and wherein the maximum value for the second speed setting is automatically determined further based on the value corresponding to traction of the work vehicle.

8. The method of claim 7, wherein a maximum value for the first speed setting is automatically determined based on at least the value corresponding to traction of the work vehicle.

9. The method of claim 1, further comprising:
receiving and storing historical input data sets comprising the one or more work vehicle operating values corresponding to at least the orientation and the advance speed of the work vehicle, and the sensed steering angle; and
training a model correlating the input data sets to observed outcomes relating to orientation or traction of the work vehicle with respect to a ground surface being traversed;
wherein values for the first speed setting, the second speed setting, and the sensitivity value for a current work vehicle operation are specified automatically by reference to the trained model.

10. The method of claim 9, wherein the received and stored input data sets further relate to a respective type of work vehicle operation, and the at least initial values for the first speed setting, the second speed setting, and the sensitivity value are specified automatically by reference to the developed model and a current type of work vehicle operation.

11. A work vehicle, comprising:
a plurality of ground engaging units configured to be driven according to a commanded advance speed;
a work implement movable to define a height relative to a ground surface;
one or more sensors configured to generate output signals corresponding to at least a steering angle, an orientation, and an advance speed of the work vehicle; and
a controller configured, at least while a cruise control operating mode is enabled:
upon determining the steering angle corresponds to forward advance by the work vehicle, to command an advance speed for the work vehicle to a first speed setting; and
upon determining that the steering angle exceeds a specified sensitivity value, to command the advance speed for the work vehicle to a second speed setting,
wherein at least a maximum value for the second speed setting is automatically determined based on at least the one or more work vehicle operating values corresponding to the orientation of the work vehicle.

12. The work vehicle of claim 11, wherein at least initial values for the first speed setting, the second speed setting, and the sensitivity value are specified by user input received via a user interface.

13. The work vehicle of claim 12, wherein the controller is configured to validate or automatically adjust the initial values for the first speed setting, the second speed setting, and the sensitivity value according to a specified type of work vehicle operation.

14. The work vehicle of claim 11, wherein a maximum value for the first speed setting is automatically determined based on at least the one or more work vehicle operating values corresponding to the orientation of the work vehicle.

15. The work vehicle of claim 11, wherein the work implement comprises a cutting deck having a cut height, and wherein the cut height is automatically adjusted from a first height setting to a second height setting upon determining that a sensed steering angle exceeds the specified sensitivity value.

16. The work vehicle of claim 15, wherein a maximum value for the second height setting is automatically determined based on at least the one or more work vehicle operating values corresponding to the orientation of the work vehicle.

17. The work vehicle of claim 11, wherein the controller is configured to calculate a value corresponding to traction of the work vehicle with respect to a ground surface being traversed, and wherein the maximum value for the second speed setting is automatically determined further based on the value corresponding to traction of the work vehicle.

18. The work vehicle of claim 17, wherein a maximum value for the first speed setting is automatically determined based on at least the value corresponding to traction of the work vehicle.

19. A system for adaptive cruise control of the work vehicle of claim 11, comprising one or more processors configured to:
receive and store historical input data sets comprising the one or more work vehicle operating values corresponding to at least the orientation and the advance speed of the work vehicle, and the sensed steering angle;
train a model correlating the input data sets to observed outcomes relating to traction of the work vehicle with respect to a ground surface being traversed; and
transmit the trained model to the work vehicle,
wherein values for the first speed setting, the second speed setting, and the sensitivity value for a current work vehicle operation are specified automatically by the controller with reference to the trained model.

20. The system of claim 19, wherein the received and stored input data sets further relate to a respective type of work vehicle operation, and the at least initial values for the first speed setting, the second speed setting, and the sensitivity value are specified automatically by reference to the developed model and a current type of work vehicle operation.
